(19) United States
(12) Patent Application Publication
(10) Pub. No.: US 2014/0175804 A1
(43) Pub. Date: Jun. 26, 2014

(54) METHOD AND APPARATUS OF GENERATING POWER FROM ATMOSPHERIC PRESSURE AND VACUUM

(71) Applicant: WEN-SHOW OU, BELLEVUE, WA (US)

(72) Inventor: WEN-SHOW OU, BELLEVUE, WA (US)

(21) Appl. No.: 13/892,322

(22) Filed: May 13, 2013

(30) Foreign Application Priority Data
Dec. 26, 2012 (TW) 101150087

(51) Int. Cl. F03B 17/00; F03B 13/00

(52) U.S. Cl. CPC F03B 17/005; F03B 13/00; F03B 17/04
USPC 290/1 A; 60/639; 415/916

(57) ABSTRACT

A method and apparatus utilizing atmospheric pressure and vacuum force to generate electricity by pushing water in a water tank through an upward pipeline to a first vacuum tank and letting the water flow down to strike against the vanes of a hydraulic power generator installed in a second vacuum tank to generate electricity. Intermediate vacuum tanks may be added between the water tank and the first vacuum tank to raise the altitude of the first vacuum tank to increase the impact of the down-flowing water. The method and the device used is not affected by local climate. The device can be installed in the backyard of a house or in a factory, operating around the clock in all seasons. The apparatus may be used to deliver water to a high altitude for water distribution.

### CROSS REFERENCE TO RELATED APPLICATIONS

This application claims priority of Taiwan Patent Application No. 101150087, filed on Dec. 26, 2012, the entirety of which is incorporated by reference herein.

### BACKGROUND OF THE INVENTION

1. Field of the Invention

This invention relates to a method and apparatus of generating power. More particularly, this invention uses atmospheric pressure and vacuum to push water inside a pipeline to a maximum of about 10.33 meter and let the water flow downwards to strike against the vanes of a hydraulic power generator (i.e. a turbine) to rotate the vanes for generation of electricity.

2. Description of the Related Art

Power mostly comes from burning of petroleum. It has led to a greenhouse effect and El Niño phenomenon, thereby threatening life on earth. As a result, using green energy, such as solar energy, wind power, terrestrial heat, tides, etc., is a goal to pursue for the inventor of the present invention.

Solar power energy is of very limited usefulness at nighttime and during cloudy days; wind power energy is limited during windless days or in faint breezes; reservoir power energy is limited during dry seasons; tidal current power energy and wave power energy are required to operate in the seaside and are adversely affected by direct/reversed tides and stand of tide. Moreover, these methods require transmission and distribution facilities, which are costly.

In view of the above-mentioned disadvantage, the inventor undertook an in-depth analysis and research and, having endeavored for a long time and experimented repeatedly, finally completed the present invention.

### BRIEF SUMMARY OF THE INVENTION

The purpose of this invention is to produce electricity by atmospheric pressure and vacuum. Atmospheric pressure and vacuum are utilized to push water column inside a pipeline to reach a maximum height of about 10.33 meters in any diameter of pipeline due to Pascal's Law. Once the water reach a needed height, a sufficient amount of water is allowed to flow downwards to strike on the turbine of a hydraulic power generator to produce electricity.

The apparatus according to the present invention includes a main water tank containing water in communication with the atmosphere; an upward pipeline connecting the main water tank to a first vacuum tank, which is positioned at a desired height above the main water tank and is connected to a second vacuum tank below by a downward pipeline and a nozzle. A power generation device including a water wheel, an accelerator and a generator is installed inside the second vacuum tank. In addition, a cylinder including an upper module and a lower module is connected to the second vacuum tank and the main water tank to control and direct the water out of the second vacuum tank and to the main water tank. When a vacuum is created in the first vacuum tank, the water in the main water tank follows through the upward pipeline to the first vacuum tank; when a vacuum is created in the second vacuum tank and the water in the first vacuum tank is allowed to flow down through the downward pipeline, the water strikes at and rotates the water wheel to cause the generator to generate electricity. The water in the second vacuum tank is controlled and directed by the cylinder to flow out into the upper module of the cylinder then back to the main water tank.

By adding intermediate sets of vacuum tank, cylinder and water tank to the apparatus between the main water tank and the first vacuum tank, the first vacuum tank can be raised to essentially any desired altitude, thereby increasing the impact force of the down-flowing water on the water wheel for higher power generation.

Lastly, repeating sets of water tank, vacuum tank and cylinder may be connected sequentially to deliver water to a high altitude for water distribution in tall buildings.

Such apparatus can run 24 hours a day, 7 days a week. It can be directly installed in the backyard of a house or in a factory, regardless of whether it is in a frigid zone, temperate zone, or torrid zone. It generates electricity at zero-carbon, at low cost, and reduces the use of fossil fuel.

In order to make the purpose, effects and characteristics of this invention understood more specifically, preferred embodiments are illustrated below, accompanied by figures.

### BRIEF DESCRIPTION OF THE DRAWINGS

FIG. 1 shows a sketch of the apparatus utilizing atmospheric pressure and vacuum to produce energy according to a first preferred embodiment of the present invention.

FIG. 2A illustrates the operations of the cylinder in directing water out of the second vacuum tank into the upper module according to the present invention.

FIG. 2B illustrates the operations of the cylinder in directing water out of the upper module back to the main water tank according to the present invention.

FIG. 3 illustrates the apparatus with one or more intermediate sets of vacuum tank, cylinder and water tank according to the present invention to increase the altitude of the water for more power generation.

FIG. 4 illustrates the apparatus with repeating sets of water tank, vacuum tank and cylinder according to the present invention for delivering water to a high altitude for water distribution in tall buildings or other high locations.

### DETAILED DESCRIPTION OF THE INVENTION

The apparatus and the method for generating electricity utilizing atmospheric pressure and vacuum is illustrated by the preferred embodiments described below.

### Embodiment I

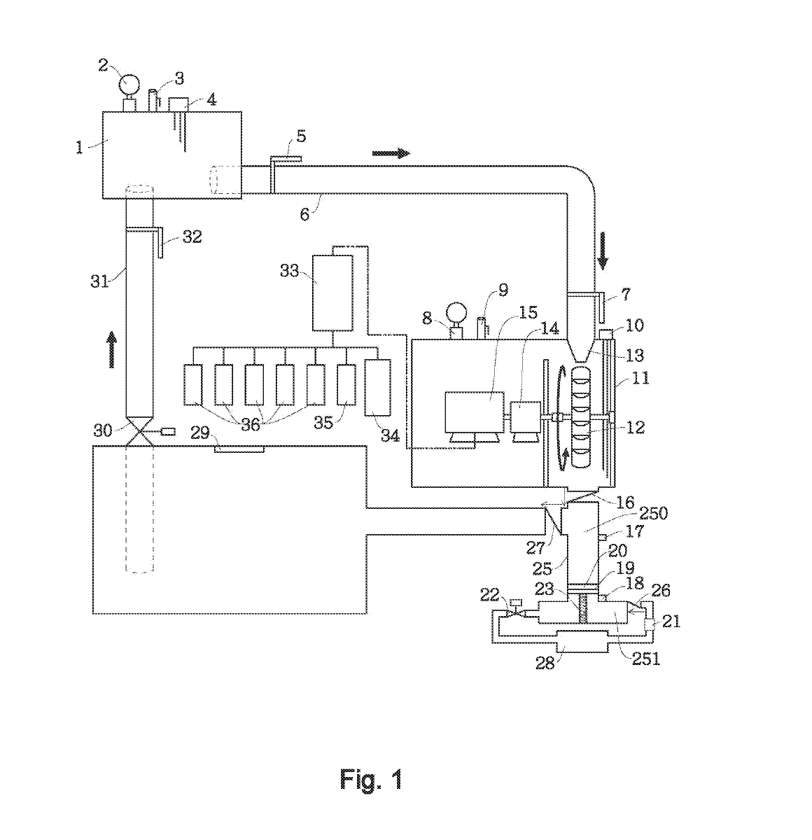

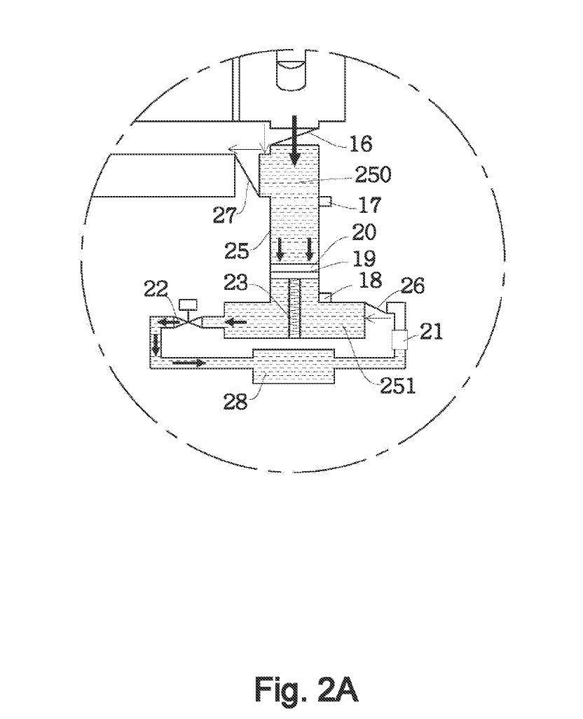

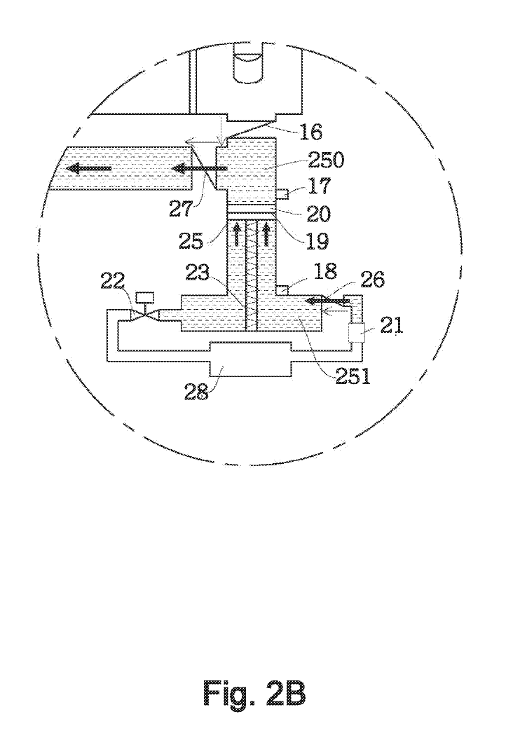

A first embodiment of the apparatus for generating power using atmospheric pressure and vacuum according to the present invention is illustrated in FIG. 1, FIG. 2A and FIG. 2B. The apparatus includes: a main water tank 29 containing water in communication with the atmosphere; a first vacuum tank 1 positioned at a desired height (of no more than 10.33 meter) above the main water tank 29; an upward pipeline 31 connecting the main water tank 29 to the first vacuum tank 1; a second vacuum tank 11 positioned below the first vacuum tank 1; and a downward pipeline 6 connecting the first vacuum tank 1 to the second vacuum tank 11.

The first vacuum tank 1 is equipped with a ball valve 3 (for drawing air to create vacuum), a vacuum pressure gauge 2, and a liquid-level probe 4. The first vacuum tank 1 is connected to the top of the main water tank 29 by an upward pipeline 31 so that there is a proper height differential (10.33 meters at most) between the main water tank 29 and the first vacuum tank 1. The upper pipeline 31 is equipped with a normal-open solenoid valve 30 and a ball valve 32 for liquid.

The second vacuum tank 11 is equipped with a ball valve 9 (for drawing air to create vacuum), a vacuum pressure gauge 8, and a liquid-level probe 10. As mentioned above, the second vacuum tank 11 is positioned below the first vacuum tank 1 and connected thereto by a downward pipeline 6 so that there is a proper height differential between the first vacuum tank 1 and the second vacuum tank 11. The downward pipeline 6 is equipped with ball valves 5 and 7 for liquid, and the lower end of the downward pipeline 6 is fitted with a nozzle 13. Inside the second vacuum tank 11 is installed a power generation device, which includes a water wheel 12 placed in a position corresponding to the nozzle 13, an accelerator 14 connected to the water wheel 12, and a generator 15 connected to the accelerator 14.

In addition, a cylinder 25 is connected to the second vacuum tank 11 and the main water tank 29 to control and direct the water out of the second vacuum tank 11 and back to the main water tank 29. The cylinder 25 comprises an upper module 250 and a lower module 251 separated by a cylinder piston component. The upper module 250 is connected to the second vacuum tank 11 and the main water tank 29 via a check valves 16 and 27, respectively. The lower module 251 is connected to an accessory water tank 28 via a normal-open solenoid valve 22 and to a pump 21 for the accessory water tank 28 via a check valve 26. The cylinder piston component comprises a spring 23 connected to the lower module 251, and a cylinder piston 20 connected to the spring 23. On the cylinder piston 20 is mounted a ferrogum 19 (rubber magnet). The outside of upper module 250 and the lower module 251 are equipped with a normal-close upper-limit reed switch 17 and a normal-open lower-limit reed switch 18, respectively.

With the above-described apparatus, the method according to the present invention to produce energy using atmospheric pressure and vacuum proceeds as follows: air is drawn out through the ball valve 3 of the first vacuum tank 1 and the ball valve 9 of the second vacuum tank 11, respectively, to create a vacuum inside the first vacuum tank 1 and the second vacuum tank 11. At this point, the water in the main water tank 29 in communication with the atmosphere is pushed up into the first vacuum tank 1 through the upward pipeline 31 due to the pressure of the atmosphere. The water then runs along the downward pipeline 6 and through the nozzle 13 to form a jet stream, which strikes onto and rotate the water wheel 12 and thereby causes the accelerator 14 and the generator 15 to generate electricity. The electricity generated by the generator 15 can be transmitted to the main power switch 33 through a cable line and then distributed to each of the sub-power switches 34, 35, 36 for supplying the power system and for use by end users. In this embodiment, one of the sub-power switches 35 controls the operations of the liquid-level probes 4,10 and the normal-open solenoid valve 30.

Subsequently, the water that strikes on the water wheel 12 flows into the upper module 250 of the cylinder 25 through a check valve 16 which connects the bottom of the second vacuum tank 11 to the upper module 250. The cylinder 25 operates by sensing the rubber magnet 19 inside the cylinder 25 with the normal-close upper-limit reed switch 17 and the normal-open lower-limit reed switch 18 separately from outside the cylinder piston 20. As shown in FIG. 2A, when the cylinder piston 20 comes near the normal-open reed switch 18 due to the pull of the spring 23, the loop of the sub-power switch 34 is closed and connected instantly, which activates the pump 21. At the same time, the normal-open solenoid valve 22 is closed so that the pump 21 delivers the water from the accessory water tank 28 into the lower module 251 through the check valve 26. This raises the liquid level inside the lower module 251 while bringing the cylinder piston 20 to move toward the upper module 250. This makes the cylinder piston 20 to press the water inside the upper module 250, and the water returns to the main water tank 29 through the check valve 27. Moreover, as shown in FIG. 2B, when the cylinder piston 20 gradually reaches the position of the normal-close upper-limit reed switch 17, the magnetic of the ferrogum 19 on the cylinder piston 20 actuates the normal-close upper-limit reed switch 17 to disconnect the power to the pump 21 and the pump 21 stops. At the same time, the normal-open solenoid valve 22 is opened, and the spring 23 pulls the cylinder piston 20 to its original position and the cylinder piston 20 presses the water to return to the accessory water tank 28. Therefore, the liquid pressure inside the lower module 251 is zero and another cycle starts accordingly.

The normal-close upper-limit reed switch 17 and the normal-open lower-limit reed switch 18 can be installed with a time controller (not shown) as needed. That way, both switches 17,18 may control the times when the pump 21 is turned on and off and when the normal-open solenoid switch 22 is opened and closed, and may also control the quantity of water stored inside the upper module 250.

According to the foregoing description, this method according to the present invention produces liquid's flow by raising the altitude of water and pressure difference. This enables the liquid to strike against the water wheel 12 of the generator 15 and rotate the water wheel 12 to generate power 24 hours a day, 7 days a week. The apparatus can be installed in the backyard of a house or in a factory, regardless of whether it is in a frigid zone, temperate zone, or torrid zone. It can generate power at zero-carbon at low cost and reduce the use of fossil fuel.

### Embodiment II

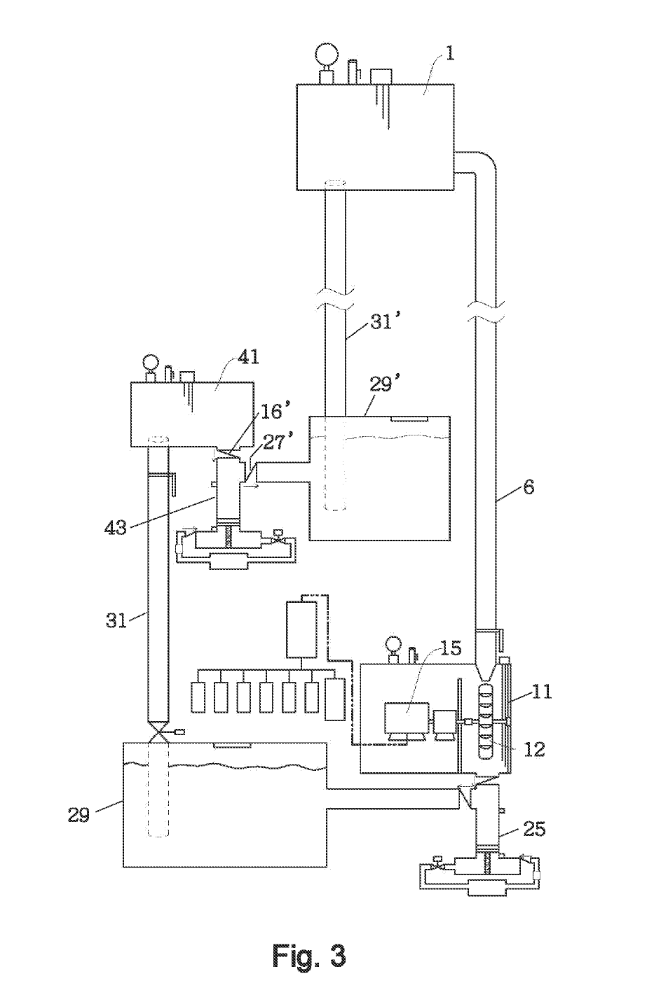

FIG. 3 illustrates a second embodiment of the present invention. Because the atmospheric pressure pushes the water to a high altitude, the method and apparatus of the present invention are not limited by the size of pipeline diameter. Therefore, the size of the pipelines can be increased as needed. And as for the height of the rising level, a number of intermediate vacuum tanks 41, intermediate water tanks 29′ and intermediate cylinders 43 can be connected between the main water tank 29 and the first vacuum tank 1 as shown in FIG. 3 to increase the height of the first vacuum tank 1 so that more impact force can be produced against the water wheel 12 to produce more electricity by the generator 15 (for example, high horsepower hydraulic power generators used in a water dam). In FIG. 3, the intermediate vacuum tank 29′ is connected to the upward pipeline 31; the intermediate cylinder 43 has the same structure and operates in a similar way as the cylinder 25 described earlier, however, it is connected to the bottom of the intermediate vacuum tank 41 via a check valve 16′ and to the intermediate water tank 29′ via a check valve 27′. The intermediate water tank 29′ is then connected via an upward pipeline 31′ to another intermediate vacuum tank 41, if any, or to the first vacuum tank 1. FIG. 3 in this invention illustrates only one set of intermediate vacuum tank 41, water tank 29′ and cylinder 43 for the apparatuses. However, this invention is not limited to any particular number of the intermediate units to be connected.

### Embodiment III

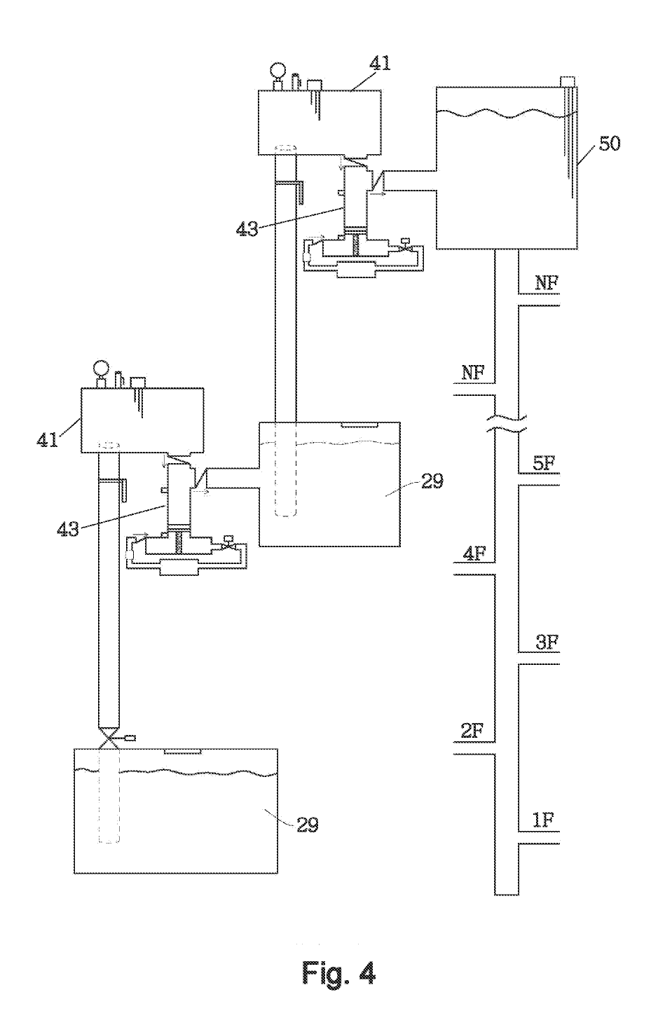

Please refer to FIG. 4. There are a large number of high buildings in the world. Clean water needs to be delivered to the top of a building and then distributed to each floor for daily use of sanitary equipment, showers, washing, drinking . . . etc. Delivering clean water to high floors requires a pump with a high horsepower motor, which consumes a large amount of electricity. The apparatus comprises a number of repeating sets of water tank 29, vacuum tank 41 and cylinder 43, and a water distributing tank 50 connected to the cylinder 43 of the last repeating set. The water tank 29, the vacuum tank 41 and the cylinder 43 in each repeating set have the same structure and function and are interconnected in the same way as in the apparatus illustrated in FIG. 3, which is described under Embodiment II above. The water distributing tank 50 at the highest altitude can then distribute water to individual floors. (In FIG. 4, 1F stands for the first floor, 2F for the second floor, etc.)

The apparatus according to this invention uses little power to deliver clean water from the main water tank 29 to a high place, which is not limited to any height. Vacuum and the atmospheric pressure are employed to realize the energy-saving device. FIG. 4 in this invention illustrates only two repeating sets of the units utilizing atmospheric pressure and vacuum. However, this invention is not limited to any particular number of repeating sets to be connected.

### BENEFITS AND ADVANTAGES OF THE INVENTION

From the foregoing, this invention has the following advantages:

1. In the method described by this invention utilizing atmospheric pressure and vacuum force to produce energy, vacuum force and the atmospheric pressure are utilized to push water column inside a pipeline to maximum height of 10.33 meters and is not limited to any diameter of the pipeline due to Pascal's Law. Once these water columns rise to a needed height, water is allowed to strike against the turbine of a hydraulic generator to rotate the turbine to generate electricity.
2. In the method described by this invention utilizing atmospheric pressure and vacuum force to produce energy, the user can connect a number of devices as needed to push the liquid to a needed height for use. That way, more impact force can be generated against the water wheel or turbine of a generator. This will allow the power generator to produce more electricity.
3. The method consumes little electricity to deliver clean water from the main water tank at a low place to a high place for residential use in tall buildings. This saves energy and is convenient to utilize.

In the apparatus of the present application, water is used due to its great abundance and wide availability on earth. However, other liquids can certainly be used instead of water.

A search throughout technical documents of such structure did not find any identical or similar structure existing prior to this application. Therefore, this invention meets patentability requirements and should be patentable.

The foregoing are merely some preferred embodiments of this invention and should not limit the claims of the present application as a result. Changes of equivalent structures which apply this invention's instructions and claims are all included in the claims of this invention for the same reason.

What is claimed is:

1. An apparatus for generating electricity, comprising:
a main water tank containing water in communication with the atmosphere;
a first vacuum tank positioned at a predetermined height above the main water tank;
an upward pipeline connecting the main water tank to the first vacuum tank;
a second vacuum tank below the first vacuum tank;
a downward pipeline connecting the first vacuum tank to the second vacuum tank, wherein a nozzle is fitted at the lower end of the downward pipeline;
a power generation device installed in the second vacuum tank; and
a cylinder connected to the bottom of the second vacuum tank and to the main water tank for directing water out of the second vacuum tank and to the main water tank,
whereby when a vacuum is created in the first vacuum tank, the water in the main water tank follows through the upward pipeline to the first vacuum tank; when a vacuum is created in the second vacuum tank and the water in the first vacuum tank is allowed to flow down through the downward pipeline and the nozzle, the water impacts on the power generation device to generate electricity; and the water in the second vacuum tank is controlled and directed by the cylinder to flow into the cylinder then back to the main water tank.

2. The apparatus as claimed in claim 1, wherein
the first vacuum tank is equipped with a ball valve for drawing air to create a vacuum inside the first vacuum tank; and
the second vacuum tank is equipped with a ball valve for drawing air to create a vacuum inside the second vacuum tank.

3. The apparatus as claimed in claim 1, wherein the cylinder comprises an upper module and a lower module separated by a cylinder piston component,
wherein the upper module is connected to the second vacuum tank and the main water tank respectively via two check valves;
the lower module is connected to an accessory water tank via a normal-open solenoid valve and to a pump for the accessory water tank via a check valve;
a normal-close upper-limit reed switch and a normal-open lower-limit reed switch are respectively mounted on outside of the upper module and outside of the lower module of the cylinder; and
the cylinder piston component comprises a spring connected to the lower module and a cylinder piston connected to the spring, wherein a rubber magnet is mounted on the cylinder piston,
whereby when the cylinder piston is lowered to the normal-open lower-limit reed switch by water flowing from the second vacuum tank into the upper module of the cylinder, the normal-open solenoid valve of the lower module is closed and the pump for the accessory water tank is actuated to pump water from the accessory water tank to the lower module of the cylinder to push the cylinder piston upward, pressing water out of the upper module and into the main water tank, until the normal-close upper-limit reed switch is reached, at which point the pump for the accessory water tank is turned off and the normal-open solenoid valve is opened.

4. The apparatus as claimed in claim 1, wherein
the first vacuum tank is equipped with a liquid-level probe; and
the upward pipeline is equipped with a normal-open solenoid valve,
whereby the normal-open solenoid valve on the upward pipeline will close when water in the first vacuum tank reaches a certain level.

5. The apparatus as claimed in claim 1, wherein
the second vacuum tank is equipped with a liquid-level probe; and
the upward pipeline is equipped with a normal-open solenoid valve,
whereby the normal-open solenoid valve on the upward pipeline will close when water in the second vacuum tank reaches a certain level.

6. The apparatus as claimed in claim 3, wherein
the normal-close upper-limit reed switch and the normal-open lower-limit reed switch are each provided with a time controller for allowing the normal-close upper-limit reed switch and the normal-open lower-limit reed switch to control the pump for the accessory water tank and opening time and closing times of the normal-open solenoid valve of the cylinder.

7. The apparatus as claimed in claim 1, wherein the power generation device includes a water wheel, an accelerator connected to the water wheel and a generator connected to the accelerator.

8. The apparatus as claimed in claim 1, wherein one or more intermediate sets of units, separated by a predetermined height from each other, are connected in an upward sequence between the main water tank and the first vacuum tank along the upward pipeline, each intermediate set of units comprising:
a vacuum tank, a cylinder, and a water tank containing water in communication with the atmosphere,
wherein the cylinder is connected to the bottom of the vacuum tank and to the water tank for directing water out of the vacuum tank and to the water tank, and
the water tank is connected upward to the vacuum tank of the next intermediate set of units in the upward sequence or, for the last intermediate set of units in the upward sequence, to the first vacuum tank, which is located at a predetermined height above.

9. An apparatus for delivering water to a high altitude, comprising:
a water distributing tank and a plurality of repeating sets of units connected in an upward sequence, each repeating set of units comprising:
a water tank main containing water in communication with the atmosphere;
a vacuum tank positioned at a predetermined height above the water tank;
an upward pipeline connecting the water tank to the vacuum tank; and
a cylinder connected to the bottom of the vacuum tank and to the water tank of the next repeating set of units in the upward sequence or, for the last repeating set of units in the upward sequence, to the water distributing tank, wherein the cylinder is adapted for directing water out of the vacuum tank and to the water tank or the water distributing tank connected thereto,
wherein a downward pipeline is connected to the water distributing tank for distributing water from the water distributing tank.

10. A method of generating electricity, comprising:
providing an apparatus as claimed in claim 1;
creating a vacuum in the first vacuum tank, thus allowing the water in the main water tank to flow through the upward pipeline to the first vacuum tank;
creating a vacuum in the second vacuum tank; and
causing the water in the first vacuum tank to flow downward through the downward pipeline and the nozzle to impact on the power generation device, causing the power generation device to generate electricity.

11. The method of generating electricity as claimed in claim 10, wherein the water flows downward from the first vacuum tank by free fall.

12. The method of generating electricity as claimed in claim 10, wherein the first vacuum tank is positioned at a height no more than 10.33 meter above the main water tank.

13. The method of generating electricity as claimed in claim 10, wherein
the power generation device includes a water wheel, an accelerator connected to the water wheel and a generator connected to the accelerator, and
the water flowing down from the first vacuum tank through the downward pipeline and the nozzle impacts on the water wheel to cause the generator to generate electricity.

14. A method of generating electricity, comprising:
providing an apparatus as claimed in claim 8;
creating a vacuum in the vacuum tank of each intermediate sets of units and in the first vacuum tank, thus allowing the water in the main water tank to flow through the upward pipeline and through the intermediate sets of units in the upward sequence to reach the first vacuum tank;
creating a vacuum in the second vacuum tank; and
causing the water in the first vacuum tank to flow downward through the downward pipeline and the nozzle to impact on the power generation device, causing the power generation device to generate electricity.

15. The method of generating electricity as claimed in claim 14, wherein
the power generation device includes a water wheel, an accelerator connected to the water wheel and a generator connected to the accelerator, and
the water flowing down from the first vacuum tank through the downward pipeline and the nozzle impacts on the water wheel to cause the generator to generate electricity.
